(19) United States
(12) Patent Application Publication
(10) Pub. No.: US 2009/0208015 A1
(43) Pub. Date: Aug. 20, 2009

(54) OFFLINE CONSUMPTION OF PROTECTED INFORMATION

(75) Inventors: Pankaj Mohan Kamat, Kirkland, WA (US); Duncan G. Bryce, Redmond, WA (US); Scott C. Cottrille, Sammamish, WA (US); Gregory Kostal, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/032,279

(22) Filed: Feb. 15, 2008

(51) Int. Cl. H04L 9/00; G06F 12/14

(52) U.S. Cl. 380/277; 713/193

(57) ABSTRACT

The offline consumption and publication of protected information in a networked environment. The offline consumption of protected information is accomplished by having the consuming user maintain a store of asymmetric encryption keys. The protected information is encrypted by the publishing user using a symmetric key and the symmetric key is then encrypted using a public asymmetric key associated with the consuming user. The consuming user received the protected information and a usage policy containing the encrypted symmetric key. The consuming user verifies that it can decrypt the symmetric key using a private asymmetric key maintained by the consumer. The user then decrypts the symmetric key and accesses the content of the protected information.

### CROSS-REFERENCE TO RELATED APPLICATIONS

Not Applicable

### BACKGROUND

Computers are useful for the general exchange of information between different computer users. Often, it is desirable for the information transferred between users be protected so that only the desired targets are able to access the information.

In order to protect information transferred in a distributed computer environment such as a network, the information to be protected, or protected information, is typically encrypted and readable only to those clients having a key to decrypt the protected information. In addition to being able to access the protected information, it also important to know what security policies should be applied to the protected information when it is accessed.

Currently, a user creates protected information and specifies a usage policy for the information to be protected. The protected information is encrypted to a policy server using a content key that is then encrypted using a cryptographic key that only a policy server has access to. The encrypted content key is stored within the usage policy and the usage policy is signed using a cryptographic operation. The protected information is then distributed to consuming users. Because the protected data is encrypted, the consuming user is unable to access the data without obtaining a usage license from a policy server that has access to the cryptographic key used to encrypt the content key. In order to obtain a usage license to access the protected data, the consuming user provides the usage policy to the policy server and an authenticated identification of the consuming user. The policy server can then make a determination if the consuming user was given access to the protected information by the publishing user.

Once the policy server determines that the consuming user was granted access by the publishing user, the policy server creates a usage license specifically targeted to the consuming user. Typically, the usage license includes a content key encrypted by the policy server and accessible by the consuming user as well a digital signature used to sign the usage license. The consuming user can then use the content key to decrypt the protected data.

If the usage policy does not specifically identify the consuming user and instead identifies a group that the consuming user is a member of, then the policy server must expand the group to verify that the consuming user is a member of the group. If the consuming user is a member of a subgroup of a group, the subgroup must be expanded as well. This process is then repeated for each consuming user that receives the protected information.

### BRIEF SUMMARY

The concepts described in this application are generally directed to embodiments for the offline consumption of protected information.

In general, there are at least two aspects to the distribution and consumption of protected information. One aspect is protecting the information in such a way that the information can only be accessed and used by defined users. Another aspect is accessing the protected content that is directed to a user.

In one embodiment, a computing network includes a consuming user, publishing user, and a policy server. The consuming user accesses protected information originated by the publishing user without having to contact the policy server. To accomplish consuming the protected information without contacting the policy server, the consuming user maintains a private key store of at least one private key corresponding to the consuming user. The key store can be updated periodically through the use of a key server. Such updates to the key store can be performed at regular time intervals, in response to an update of the keys at the key server, on demand by a client, or other means of initiating an update. Protected information that was originated by the publishing user and encrypted using a symmetric key is received by the consuming user. The consuming user accesses a usage policy for the protected information to determine if the usage policy contains an encrypted content key that can be decrypted using a specific private key corresponding to the consuming user. The consuming user checks locally to find the corresponding private key and if the key is maintained by the consuming user, then the consuming user uses the specific private key to decrypt the symmetric key contained in the usage policy. The consuming user can then decrypt the protected information using the content key without communication to the policy server.

In another embodiment, the computing network includes a publishing user, a consuming user, and a server. The publishing user publishes protected information for consumption by the consuming user by maintaining a store of public asymmetric keys associated with potential consuming users and groups of users. The protected information is encrypted using a symmetric content key and prior to publishing the protected information, it is determined if the store of public asymmetric keys contains a particular public asymmetric key associated with the consuming user and/or a key server. If it is determined that the store of public asymmetric keys contains the particular public asymmetric key associated with the consuming user and/or a key server, the symmetric content key is encrypted utilizing the public asymmetric key associated with the consuming user and/or a key server and the encrypted symmetric content key is added to a usage policy for the protected information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the invention briefly described above will be rendered by reference to specific embodiments thereof which are illustrated in the appended drawings. Understanding that these drawings depict only typical embodiments and are not therefore to be considered to be limiting of the scope of the invention, the embodiments will be described and explained with additional specificity and detail through the use of the accompanying drawings in which:

FIG. 1 illustrates a suitable operating environment in which to implement the described embodiments.

FIG. 2 illustrates a suitable network environment in which protected information can be created, distributed, and securely consumed.

FIG. 3 illustrates a flowchart corresponding to a method for the consuming user access the protected information.

FIG. 4 illustrates a flowchart corresponding to a method for the publishing user to securely publish the protected information.

### DETAILED DESCRIPTION

The concepts described in this application are generally directed to embodiments the offline consumption of protected information. In some cases, the embodiments can comprise a special purpose or general-purpose computer including various computer hardware and/or firmware and/or software, as discussed in greater detail below.

In general, there are at least two aspects to the distribution and consumption of protected information. One aspect is protecting the information in such a way that the information can only be accessed and used by defined users. Another aspect is accessing the protected content that is directed to a user.

In one embodiment, a computing network includes a consuming user, publishing user, and a policy server. The consuming user accesses protected information originated by the publishing user without having to contact the policy server. To accomplish consuming the protecting information without contacting the policy server, the consuming user maintains a private key store of at least one private key corresponding to the consuming user. Protected information that was originated by the publishing user and encrypted using a symmetric key is received by the consuming user. The consuming user accesses a usage policy for the protected information to determine if the usage policy contains an encrypted content key that can be decrypted using a specific private key corresponding to the consuming user. The consuming user checks locally to find the corresponding private key and if the key is maintained by the consuming user, then the consuming user uses the specific private key to decrypt the symmetric key contained in the usage policy. The consuming user can then decrypt the protected information using the content key without communication to the policy server.

In another embodiment, the computing network includes a publishing user, a consuming user, and a server. The publishing user publishes protected information for consumption by the consuming user by maintaining a store of public asymmetric keys associated with potential consuming users and groups of users. The protected information is encrypted using a symmetric content key and prior to publishing the protected information, it is determined if the store of public asymmetric keys contains a particular public asymmetric key associated with the consuming user. If it is determined that the store of public asymmetric keys contains the particular public asymmetric key associated with the consuming user, the symmetric content key is encrypted utilizing the public asymmetric key associated with the consuming user and the encrypted symmetric content key is added to a usage policy for the protected information.

In this description and the claims that follow, a “principal” is defined as an individual user or a group to whom information protection policy can be applied. A “user” is defined as a user account participating in the publication and consumption of protected information. Users can be part of a “group” defined as a collection of user accounts and/or other groups. Furthermore, each user can be a member of more than one group.

There are generally two types of users described herein, a “publishing user” defined as a user that creates the protected information, and a “consuming user” defined as a user that accesses the protected information. The use of the terms publishing user and consuming user as used herein are used to identify the creator and the consumer of protected information and need not identify a unique user of the system. For instance, a user can create a first instance of protected information and consume a second instance of protected information making the user both a consuming user and a publishing user.

In this description and the claims that follow, “protected information” is defined as a resource that is encrypted using a cryptographic key and wherein access to the protected information is gated by the ability of a user to obtain the cryptographic key. The cryptographic key used to encrypt the protected information may hereafter be referred to as the “content key”. In some embodiments, the content key is a symmetric key that can be used to both encrypt and decrypt data.

A “principal key” as used herein is defined as a cryptographic key corresponding to a principal. In some embodiments, the principal key is one or the other of an asymmetric encryption key pair wherein each member of the key pair is capable of decrypting information encrypted by the other member of key pair. A key pair can be a public/private key pair. The public key can be distributed publically while the private key is held closely by the principal and not distributed. Thus a “principal key” can refer to either a public or a private key for a “principal.”

In this description and the claims that follow, the term “usage policy” is defined as an expression of policy for protected information that describes what principal can use the protected information, in what ways, and with what conditions. In some embodiments, the usage policy can contain an encrypted content key while in other embodiments, no encrypted content key may be present. The usage policy can be generated by the publishing user or could be generated by a separate process. Furthermore, the usage policy can exist separately from the protected content, or may be integral to the protected content.

In this description and the claims that follow, the term “usage license” is defined as an expression of policy for protected information wherein the usage license describes a specific principal who can use the information, in what way and with what conditions. Furthermore, a policy server generally generates the usage license in which a copy of the content key encrypted by the policy server is stored and the encrypted content key is decryptable only by the specific principal.

The term “server” is defined to generally describe a server computer while the specific terms “policy server” and “key server” are generally be used to describe specific instances of servers. A policy server is defined as a server computer that provides authentication of usage policy and issues usage licenses for specific principals. A key server is defined as a server computer that maintains a store of principal keys for use by client computers. It will be noted that while the key server and policy server are described as two separate computer systems, the key server and policy server can in fact be a single server and the functionality of the key server and policy server can be combined.

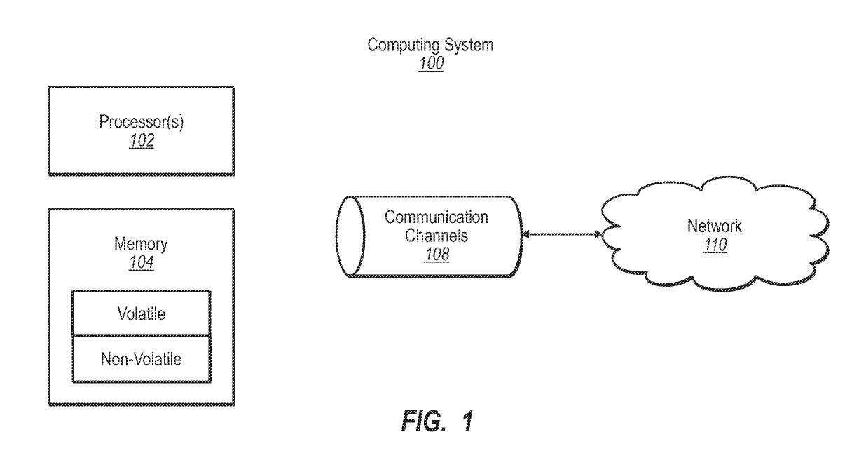

Referring to FIG. 1, in one configuration, a computing system 100 includes a processing unit 102 and memory 104. The processing unit may consist of multiple processing cores or multiple processors. The memory 104 may be physical system memory, which may be volatile, non-volatile, or some combination of the two. The term “memory” may also be used herein to refer to non-volatile mass storage such as physical storage media. As used herein, the term “module” or “component” can refer to software objects or routines that execute on the computing system. The different components, modules, engines, and services described herein may be implemented as objects or processes that execute on the computing system (e.g., as separate threads).

Computing system 100 may also contain communication channels 108 that allow the computing system 100 to communicate with other computing systems over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

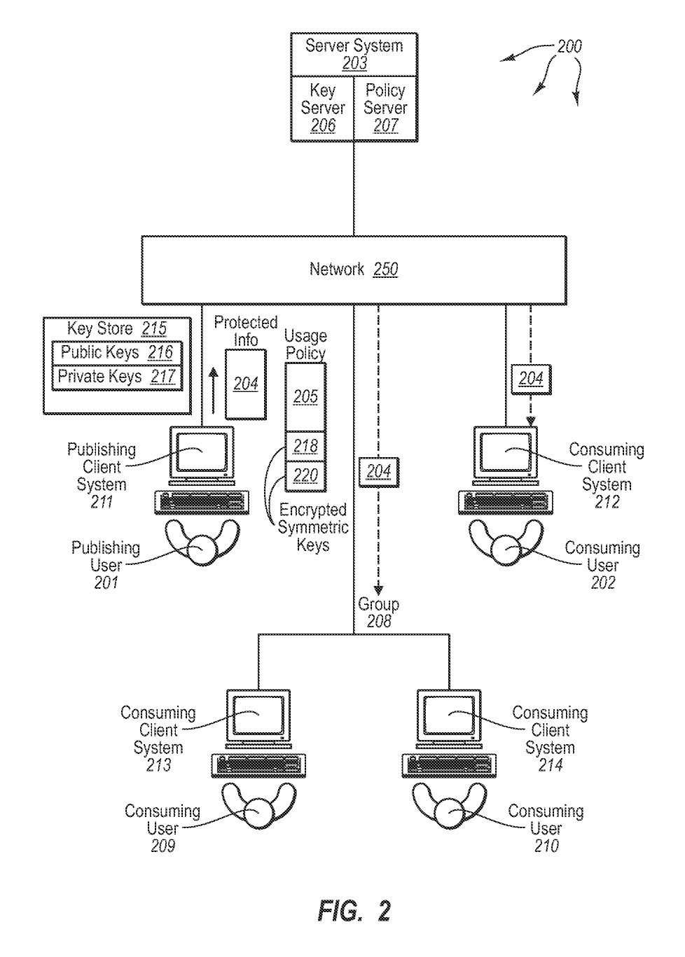

FIG. 2 shows an exemplary network architecture 200 in which the currently described embodiment may be practiced. The publishing user 201 operates a publishing client system 211 that is connected to network 250. The publishing user creates protected information 204 using publishing client system 211. In addition to the protected information 204, a usage policy 205 is created that describes who may access the protected information 204 and in what ways. The usage policy 205 can be manually defined by the publishing user 201 or can be automatically generated by the publishing client system 211 or some other computing device. The usage policy 205 in the present example is shown alongside but separate from the protected information 204. It will be understood that the usage policy 205 need not be separate from the protected information 204 (i.e. could be part of the protected information 204) and that the usage policy 205 can be delivered separate from the protected information 204. Furthermore, in the embodiment of FIG. 2, the usage policy 205 is shown as containing two encrypted symmetric content keys 218 and 220. In other embodiments, the usage policy may have more or less, than 2 encrypted symmetric content keys depending on the number of potential consuming users and public key availability.

Each client system has an encryption key store, of which an example embodiment is depicted as key store 215 where public encryption keys 216 and private encryption keys 217 are maintained. While the key store 215 is shown adjacent to the publishing client system 21 1, the key store 215 can be maintained separately from the key store's 215 associated client system. Because a client system can be both a publishing client system and a consuming client system, in one embodiment the encryption key store 215 maintains keys for both publishing and consuming. For instance if key store 215 were associated with publishing client system 211, key store 215 can contain public keys 216 corresponding to the consuming users 202, 209, and 210, and any associated groups such as group 208 that the client may publish data to. Additionally, key store 215 can contain both private keys 217 and public keys 216 corresponding to publishing user 201 and any groups that the publishing user 201 is a member of Key store 215 can additionally contain public keys associated with one or more key servers such as key server 206.

The publishing user 201 transmits the protected information 204 using network 250. The publishing user 201 can send the protected information 204 to a single consuming user 202, to a group of consuming users 208 (comprised of consuming users 209 and 210), or to any combination of single consuming users and groups of consuming users. Each of the consuming users 202, 209, and 210 have an associated consuming client system 212, 213, and 214 respectively that communicates using network 250.

The network 250 further includes at least one server system 203. The server system can contain at least a key server 206 and a policy server 207 for use by the principals. The key server 206 and policy server 207 can be contained within the same server, or can exist separately. The servers are communicatively coupled to network 250.

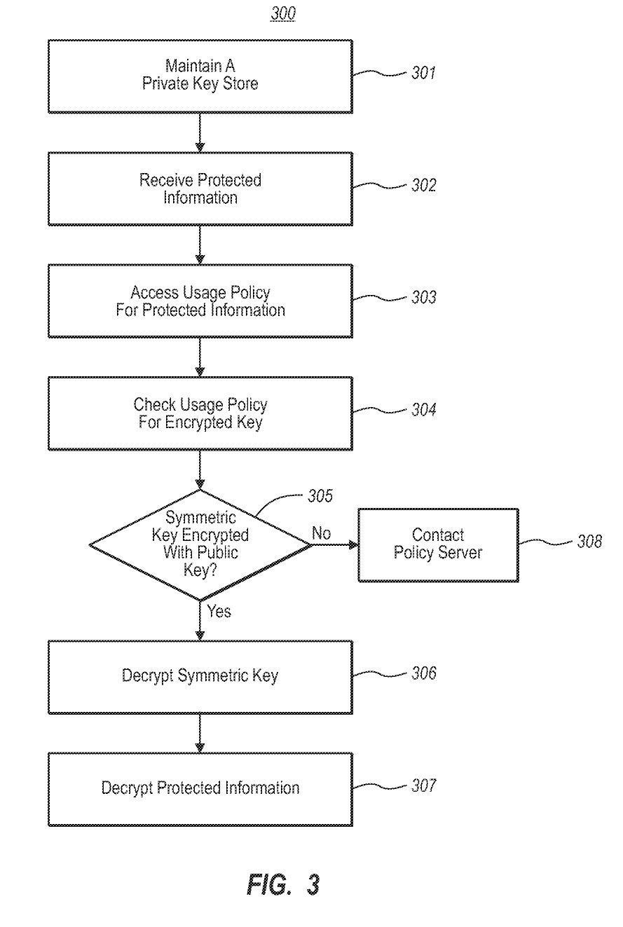

A method 300 for practicing the embodiment of a consuming user accessing protected information is shown in FIG. 3. The method 300 will be described with respect to the components and data in network architecture 200.

Method 300 includes an act of maintaining a private key store of at least one private key corresponding to the consuming user. (act 301) In some embodiments, the private key store contains only keys corresponding to groups that the consuming user is a member of The key store can be encrypted using a key known only to the consuming user in order to protect the contents of the key store.

Consuming client system 212 can maintain key store 215. Key store 215 can correspond to consuming user 202. In this example, key store 215 would contain at least a private key in private keys 217 corresponding to consuming user 202. Alternatively, the consuming user can be a member of a group, such as group 208, and the key store 215 could contain at least a private key among the private keys 217 corresponding to the group. Furthermore, the key store can contain multiple private keys 217 associated with multiple consuming users. The private keys 217 maintained in the key store 215 typically have an associated public key maintained in the key store 215 wherein the public keys 216 are distributed to potential publishing client systems such as publishing client system 211 and the private keys 217 remain with the associated consuming client system, in this example consuming client system 212. The key store can be maintained locally to the consuming client system 212, or stored in a manner readily available to the consuming client system.

In some instances, the consuming user 202 may not have the appropriate keys necessary for implementation of offline consumption of protected information. In such instances, the consuming user 202 can provision at the key server 206 wherein the appropriate keys are created for the consuming user 202 on the key server 206. The consuming user 202 can then store the newly provisioned keys in the consuming user's 202 key store 215. This process is typically done the first time that a consuming user participates in the offline consumption of protected information or, in the case of a group 208, the key can be generated at the time the publishing user 201 specifies a group for publication. Furthermore, the keys can be updated periodically in the key store 215 in the case of key expiration, revocation of keys, revocation of group membership, or other situations.

Method 300, as shown in FIG. 3 includes an act 302 of receiving protected information originated by the publishing user, wherein the protected information is encrypted using a symmetric key. For example, with reference to FIG. 2, publishing user 201 can generate and send protected information 204 using publishing client system 211. Consuming user 202 can receive the protected information 204 using network 250. Furthermore, the protected information 204 can be encrypted using a symmetric key. It is also possible that the protected information could be delivered by a means other than network 250 such as the physical transfer of a computer readable media. Because the protected information 204 was previously encrypted using a symmetric key that is unknown to consuming users, the protected information 204 remains safe and is not accessible.

In another embodiment, the protected information 204 can be published to a group of users 208 rather than a single user 202, or can be published to a combination of single users 202 and groups of users 208. In such an embodiment, multiple consuming client systems (e.g., consuming clients 213 and 214) can receive protected information 204 over network 250 from publishing client system 211.

Method 300 further includes an act 303 of the consuming user accessing a usage policy for the protected information, the usage policy containing an encrypted version of the symmetric key, the encrypted version of the symmetric key encrypted using a public key corresponding to a specific private key maintained in the private key store. Furthermore, the usage policy can contain a second encrypted version of the symmetric key encrypted using a public key corresponding to a key server. For example, consuming user 202 can use consuming client system 212 to access usage policy 205 associated with protected information 204. Usage policy 205 contains encrypted symmetric keys 218 and 220 containing encrypted versions of the symmetric content key used to encrypt the protected information 204. The encrypted symmetric keys may have been encrypted using a public key from key store 215 associated with the consuming user 202 and/or a public key from key store 215 associated with the key server 206.

The usage policy 205 may have been included with the protected information 204, can arrive separately from the protected information 204, or can be requested by the consuming user 202 at the time the protected information 204 is received. Other means for obtaining the usage policy 205 are possible and the examples given are in no way limiting as to the scope of the embodiment. The usage policy 205 typically contains encrypted symmetric keys 218 and 220 that contain encrypted versions of the content key that was used to encrypt the protected information 204.

Method 300 includes an act 304 of the consuming user locally checking the usage policy to determine that the encrypted versions of the symmetric key are encrypted with the public key corresponding to the specific private key, without communication to the policy server. As an example, the consuming client system 212 can evaluate the usage policy 205 to determine that the encrypted symmetric key 218 was encrypted using a public key corresponding to one of the private keys 217 maintained in the key store 215. It can perform this evaluation without contacting the server system 203. The usage policy 205 associated with the protected information 204 is checked in act 304 to determine if the encrypted content key is encrypted using a public key corresponding to a private key maintained in the key store.

Method 300 includes a decision 305 based on the determination of whether the content key was encrypted using a public key associated with the consuming user. It is possible that the content key was previously encrypted using a public key associated with the consuming user (Yes at decision 305). In such an instance, act 306 is performed wherein the consuming user uses the specific private key to decrypt the symmetric key contained in the usage policy. For example, consuming user 202 can cause consuming client system 212 to use a private asymmetric key from among the private keys 217 of the key store 215 to decrypt encrypted symmetric key 218.

In method 300, after the content key is decrypted, an act 307 of subsequently using the symmetric key to decrypt the protected information such that the protected information is accessed without communication to a policy server is performed. As an example, consuming user 202 can cause consuming client system 212 to decrypt protected information 204 using the decrypted symmetric key 218. In this way, the consuming user 202 can receive and decrypt the protected information 204 without ever having to communicate to the policy server 206 or the key server 207 at the time the information is received.

In method 300, if the result of decision 305 is that the content key has not been encrypted with a public key associated with the private keys in the consuming user's store (No at decision 305), then act 308 is performed wherein the consuming user can contacts the policy server 207 to retrieve a usage license. For example, consuming user 202 can contact policy server 207 using network 250 to request a usage license.

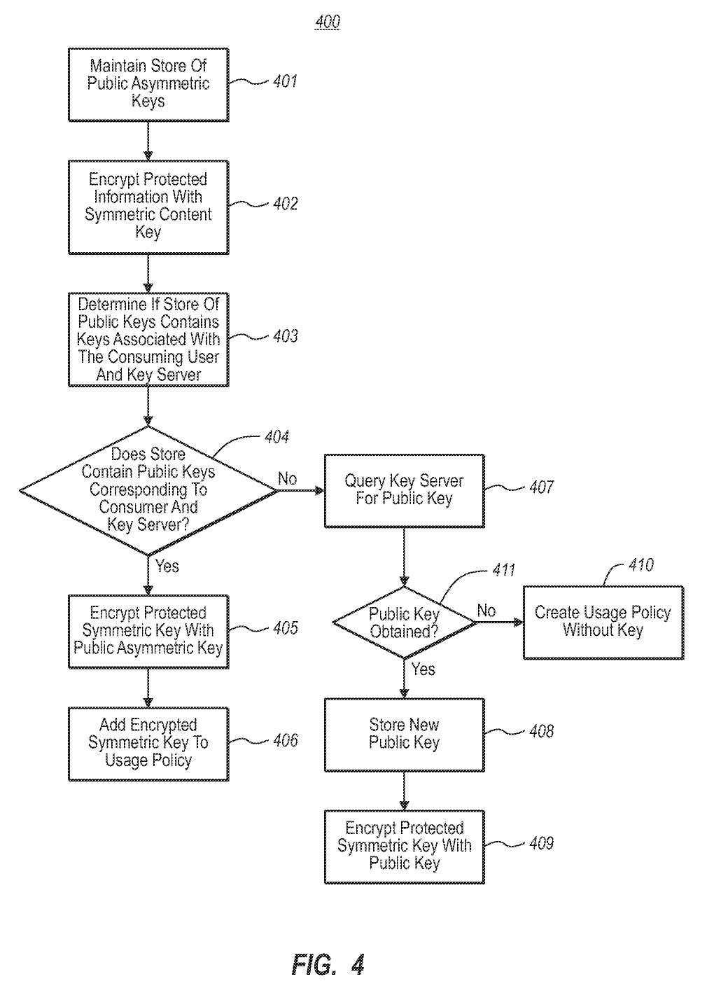

FIG. 4 shows a method 400 for publishing protected information 204 from the perspective of a publishing user 201. In act 401, the publishing user 201 maintains a store of public asymmetric keys associated with potential consuming users and groups of users, and which can contain a public key associated with a key server. In some embodiments, the key store can store all public keys corresponding to all users and groups known to the key server. The keys within the key store can be updated periodically to ensure that they are up to date. In one embodiment, the keys are updated using an out of band “mechanism” such as Background Intelligent Transfer System (BITS).

For example, with reference to FIG. 2, the publishing client system 211 can maintains the key store 215 locally, or alternatively, the key store 215 can be maintained remotely. The key store 215 can contain additional key pairs corresponding to the publishing user 201 and any groups that the publishing user 201 is a member of and can contain a public key corresponding to key server 206. Furthermore, since each user is capable of being both a publishing user 201 and a consuming user, it is possible for the key store to hold both keys for publishing and keys for consuming protected information 204.

In act 402, the protected information is encrypted using a symmetric content key. Because the content key is a symmetric key, the protected information can be decrypted using the same content key. As an example, in FIG. 2, the publishing user's 201 publishing client system 201 encrypts the protected information 204 using a symmetric content key 218.

The store of public keys is then checked in act 403 to determine if the store contains a public key associated with a private key corresponding to the intended recipients of the protected information 204 and a public key associated with a private key corresponding to a key server. As an example, publishing user 201 can check the key store 215 to determine if the public keys 216 correspond to the intended consumers such as 202, 209, and/or 210 or a group 208 of consuming users and if the public keys 216 correspond to key server 206.

In decision 404, if the store does contain the public key associated with the intended consuming users, then act 405 is performed wherein the content key is encrypted using the public key corresponding to a private key associated with the intended consuming users. (Yes at decision 404) For example, the publishing client system 211 can perform an encryption operation using a public key maintained in the store of public keys 216 to encrypt the symmetric key 218. Additionally, if the store contains a public key associated with the key server, a copy of the content key can be encrypted using the key server's public key as well. The encrypted symmetric key 218 or keys are then inserted into a usage policy for the protected information 204 in act 406. Referring to FIG. 2, publishing client system 211 inserts the encrypted symmetric key 218 into the usage policy 205.

On the other hand, if in decision 404 the key store does not contain a public key associated with the intended consuming user (no at decision 404), then act 407 is performed wherein the key server is queried to locate a public key for the intended consuming user. For example, with reference to FIG. 2, the publishing client system 211 can query the key server 206 to locate a public key for the intended consumer or groups of consumers such as consuming users 202, 209, and 210 or group 208.

In response to obtaining the public key associated with the consuming users or groups of consuming users, (yes at decision 411) act 408 is performed where a copy of the public key is stored in the key store of the publishing user. For example, publishing client system 211 can query key server 206 to request the public key associated with a consuming user such as consuming user 202 and the requested public key can then be stored with the public keys 216 in the key store 215.

In act 409, the requested public key is used to encrypt the symmetric key associated with the protected information. For example, publishing client system 211 can utilize the requested public key to encrypt the symmetric key 218. Additionally, if the store contains a public key associated with the key server, a copy of the content key can be encrypted using the key server's public key as well.

In some instances, a public key associated with the intended consuming user may not be located. (No at decision 411) For example, the server may be unavailable or may not contain information about the intended consuming user. In such instances, act 410 is performed wherein a usage policy can be created that contains a symmetric content key that has been encrypted using the key server's public key, or the usage policy may not contain a copy of the symmetric key used to encrypt the protected information. Instead, when the consuming user receives the protected information, the consuming user can contact the policy server and obtain a usage license. As an example, if publishing user 201 is unable to locate the correct public key on key server 206, then usage policy 205 can be created without encrypted symmetric key 218. The usage policy 205 and protected information 204 can be sent to the intended user or group such as consuming user 202. The consuming user 202 can then contact policy server 207 to retrieve a usage license to decrypt the protected information 204.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment comprising a consuming user, publishing user, and a policy server, a method for the consuming user to access protected information originated by the publishing user, the method comprising:
maintaining a private key store of at least one private key corresponding to the consuming user;
receiving protected information originated by the publishing user, wherein the protected information is encrypted using a symmetric key;
the consuming user accessing a usage policy for the protected information, the usage policy containing an encrypted version of the symmetric key, the encrypted version of the symmetric key encrypted using a public key corresponding to a specific private key maintained in the private key store;
the consuming user locally checking the usage policy to determine that the encrypted version of the symmetric key is encrypted with the public key corresponding to the specific private key maintained in the private key store corresponding to the consuming user, without communication to the policy server; and
in response to a determination that the symmetric key has been encrypted with the public key, the consuming user:
using the specific private key to decrypt the symmetric key contained in the usage policy; and
subsequently using the symmetric key to decrypt the protected information such that the protected information is accessed without communication to the policy server.

2. The method of claim 1 wherein maintaining a private key store comprises storing only keys corresponding to groups that the consuming user is a member of, the keys being stored in an encrypted store with the encrypted store being encrypted to a key known only to the consuming user.

3. The method of claim 1 further comprising:
in response to a determination that the symmetric key has been encrypted using a key not associated with the private asymmetric keys maintained in the store of encryption keys, connecting to a policy server to retrieve a usage license.

4. The method of claim 1, wherein the protected information is published to a group of users, wherein the public asymmetric key associated with the private asymmetric key is associated with the group of users.

5. The method of claim 1, wherein the store of content keys is maintained locally at the consuming user.

6. The method of claim 1, wherein the usage policy is recieved with the protected content associated with the usage policy.

7. The method of claim 1, wherein the usage policy is received separately from the protected content.

8. The method of claim 1, wherein the user is provisioned at a key server prior to the first instance of consuming any protected content.

9. In a computing environment comprising a consuming user and a publishing user, a method for the publishing user to publish protected information for consumption by the consuming user, the method comprising:
maintaining a store of public asymmetric keys associated with potential consuming users and groups of users;
encrypting the protected information using a symmetric content key;
prior to publishing the protected information, determining that the store of public asymmetric keys contains a particular public asymmetric key associated with the consuming user; and
in response to a positive determination that the store of public asymmetric keys contains the particular public asymmetric key associated with the consuming user,
encrypting the symmetric content key utilizing the public asymmetric key associated with the consuming user; and
adding the encrypted symmetric content key to a usage policy for the protected information.

10. The method of claim 9, wherein the store of cryptographic keys further maintains public and private asymmetric keys corresponding to the user and any groups to which the user is a member.

11. The method of claim 9, wherein maintaining a store of public asymmetric keys comprises:
storing public keys corresponding to all users and groups known to the key server; and
periodically updating at least a portion of the public asymmetric keys using an out of band update mechanism.

12. The method of claim 9, wherein the store of public asymmetric keys does not contain a public asymmetric key associated with the consuming user, the method further comprising:
querying a server to locate a public asymmetric key associated with the consuming user or group of consuming users; and
in response to locating the public asymmetric key, storing the public asymmetric key in the store of public asymmetric keys and encrypting the symmetric content key using the stored public asymmetric key.

13. The method of claim 9 further comprising:
encrypting the symmetric content key using a public asymmetric key associated with a server; and
adding the encrypted symmetric content key encrypted to the public asymmetric key associated with the server to the usage policy.

14. In a computing environment comprising a consuming user and a publishing user, a system for the consuming user to access protected information originated by the publishing user, the system comprising:
a processor executing computer-executable instructions; and
a computer-readable storage media storing the computer-executable instructions, wherein the computer-executable instructions cause the system to perform a method when executed, the method comprising:
maintaining a private key store of at least one private key corresponding to the consuming user;
receiving protected information originated by the publishing user, wherein the protected information is encrypted using a symmetric key;
the consuming user accessing a usage policy for the protected information, the usage policy containing an encrypted version of the symmetric key, the encrypted version of the symmetric key encrypted using a public key corresponding to a specific private key maintained in the private key store;
the consuming user locally checking the usage policy to determine that the encrypted version of the symmetric key is encrypted with the public key corresponding to the specific private key maintained in the private key store corresponding to the consuming user, without communication to the policy server; and
in response to a determination that the symmetric key has been encrypted with the public key, the consuming user:
using the specific private key to decrypt the symmetric key contained in the usage policy; and
subsequently using the symmetric key to decrypt the protected information such that the protected information is accessed without communication to the policy server.

15. The system of claim 14, wherein maintaining a private key store comprises storing only keys corresponding to groups that the consuming user is a member of, the keys being stored in an encrypted store with the encrypted store being encrypted to a key known only to the consuming user.

16. The system of claim 14, wherein the method the computer executable instructions cause the system to perform further comprises:
in response to a determination that the symmetric content key has been encrypted using a public asymmetric key not associated with the private asymmetric keys maintained in the store of encryption keys, connecting to a policy server to retrieve a usage license.

17. The system of claim 14, wherein the protected information is published to a group of users, wherein the public asymmetric key associated with the private asymmetric key is associated with the group of users.

18. The system of claim 14, wherein the store of content keys is maintained locally at the consuming user.

19. The system of claim 14, wherein the usage policy is received with the protected content associated with the usage policy.

20. The system of claim 14, wherein the usage policy is received separately from the usage policy.
